(19) United States
(12) Patent Application Publication
(10) Pub. No.: US 2015/0310723 A1
(43) Pub. Date: Oct. 29, 2015

(54) TRENDING MACHINE HEALTH DATA USING RFID TRANSPONDERS

(71) Applicant: Alexander Pinkerton, Aberdeen (GB)

(72) Inventor: Alexander Pinkerton, Aberdeen (GB)

(73) Assignee: Aktiebolaget SKF, Goteborg (SE)

(21) Appl. No.: 14/264,158

(22) Filed: Apr. 29, 2014

(51) Int. Cl. G08B 21/18; G06K 7/10; H04Q 9/00

(52) U.S. Cl. CPC G08B 21/182; G08B 21/187; H04Q 9/00; G06K 7/10366

(57) ABSTRACT

A system for monitoring and recording health data associated with machine. The system employs a radio frequency identification (RFID) transponder, which is affixed to the machine. The system utilizes a digital memory component of the RFID transponder to record and maintain historical measurements to aid in determining machine condition trending. The RFID transponder interacts with a machine condition advisor (MCA), where the MCA obtains a configuration and historical data from the RFID transponder, queries sensors, collects data, transfers updated data to the RFID sensor, and determines and displays condition trending. Machine condition trending can be displayed in a graphical format. Warning or alarm levels can be established enabling the system to determine machine conditions warranting alerting a machine technician. Each machine condition trending can be independent of or associated with the associated warning or alarm level.

### FIELD OF THE INVENTION

The present invention relates to a machine condition monitoring system. More specifically, the system employs a radio frequency identification (RFID) transponder affixed to the machine and a machine condition detector that interface with the RFID transponder to enable programmable monitoring and trend analysis of operating parameters of the monitored machine.

### BACKGROUND OF THE INVENTION

### Discussion of the Related Art

Machine equipment uptime is critical in optimizing output and maintaining operation of the machine. Machines may be installed in critical systems requiring continuous uptime, with planned downtime for maintenance. Unscheduled downtime can impact productivity of the machine and in more critical installations, could impact safety of individuals, property, and the like that rely upon the continuous operation of the machine.

One of the most important methods of determining the current health of any machine is by examining how measured parameters (such as temperature or vibration) have changed over some period time. For example: is the bearing temperature of a motor starting to rise, and if so, then by how much and over what period of time?

This examination of machine condition changes over time is known “Trending”, and monitoring these trends to predict and prevent machine failures, is known as Condition Monitoring.

With any machine, it is when the rate of change of any condition exceeds what should be expected, that action must be taken—and not necessarily just when the measured parameter exceeds some alarm or danger level. For example, in the event of a sudden loss of engine coolant, the time to act is when the temperature gauge suddenly starts to rise, not when the temperature alarm light illuminates!

Unfortunately, trending is not as simple as it sounds. Assuming a plant has just one machine and one only parameter of that machine is being routinely monitored, then any changes in that single parameter would quickly be picked up on. Alternately if a plant had many machines, and all parameters of those machines were being monitored continuously via an online “Condition Monitoring” system—then once again, problems would be quickly picked up on.

However, not all plants monitor all of their machine parameters using online systems, and so typically these facilities employ an “offline” condition monitoring system, and rely on their engineers to use a “route based” program to routinely check the health of each machine using offline test equipment.

Furthermore, “route based” inspection programs rely upon the use of complex and expensive handheld monitoring equipment: equipment, which not only instructs the engineer what machines to visit, but also what parameters to inspect. Although this is a highly accurate method inspecting machines (allowing trends to be viewed at time of collection), the handheld equipment itself is often expensive, heavy and extremely complex to use. This complexity of the technology, immediately limits the system to use by “expert users”, which in turn limits both the scope and frequency of machine inspections.

Back in the late 1990s, a simple, portable handheld device “Machine Condition Detector” (MCD) was available and would be attached to a machine using either magnetic mounts or Machine Quick Connect (MQC) mounted studs. Machine Quick Disconnect (MQD) smart studs could be employed, where the smart studs were similar to normal studs, whereas the smart studs contained a small amount of digital memory. These studs allowed measurements recorded by the MCD to be written to and read from this memory, allowing the MCD user to view both current and historic measurements.

The MQC smart studs were expensive, physically large, had very limited memory, relied on electric “contact based” technology (which needed a protective cap and was prone to damage and contamination), were frequently very difficult to fit, and, being a “bespoke” technology, could only be sourced from one company. Consequently, the majority of MCD users continued to use the magnetic machine mount, and MQC smart stud technology drifted into obsolescence.

The deployed known technology required remote analysis of collected data to determine trends of various conditions of the machine, such as those accomplished using “route based” hardware and associated software.

Thus, what is desired is a system and associated method of use for analyzing machinery; one that can be used by any plant operator and which supports trending without the need for complex and expensive “route based” hardware.

### SUMMARY OF THE INVENTION

The present invention is directed towards a system employing a radio frequency identification transponder for retaining historical machine data enabling determination of trends.

In a first aspect of the present invention, a machine condition monitoring system comprising:

a radio frequency identification (RFID) transponder attached to the machine, the RFID transponder comprising:
a radio frequency identification (RFID) antenna,
a radio frequency identification (RFID) transmitter in signal communication with the RFID antenna,
a radio frequency identification (RFID) receiver in signal communication with the RFID antenna,
a digital memory element including a series of memory blocks established for retaining historic measurements,
a microprocessor in signal communication with and operational control of the digital memory element, the RFID transmitter and the RFID receiver;

a machine condition advisor (MCA) comprising a sensor input and a microprocessor, wherein the microprocessor operates in accordance with a series of machine condition instructions;

a machine condition advisor (MCA) electromechanical coupler assembled to the machine, wherein the MCA electromechanical coupler obtains various conditions of the machine and transfers the various conditions to the MCA through the sensor input;

a communication link between the MCA and the RFID transponder, wherein the MCA instruction set includes a step to transfer data associated with each of the at least one machine conditions to the RFID transponder digital memory element; and

an instruction set which stores historical data associated with each of the at least one machine conditions in the RFID transponder digital memory element.

In a second aspect of the present invention, the at least one machine condition can include at least one of temperature, velocity, vibration, and the like.

In another aspect of the present invention, the at least one machine condition is transferred from the machine to the MCA through the electromechanical coupler.

In yet another aspect, the MCA is attached to the machine using a machine quick connect (MQC) mounting stud.

In yet another aspect, the at least one machine condition is transferred from the machine to the MCA through the mounting stud.

In yet another aspect, the MCA further comprises an instruction set that analyzes historical machine conditions to determine trends and present an output associated with each measurement condition respective to pre-established alarm condition levels.

In yet another aspect, the pre-established alarm condition levels can include an alert level and an alarm level.

In yet another aspect, the output can include a trend indicator.

In yet another aspect, the trend indicator can be graphically represented, such as by an arrow. The graphical indicator can additionally include an alarm indicator line, wherein the trend indicator arrow would be located on one side of the line (preferably above the line) to indicate a condition above the pre-established alarm condition level and the trend indicator arrow would be located on the other side of the line (preferably below the line) to indicate a condition below the pre-established alarm condition level.

In yet another aspect, the trend indicator arrow can be pointed upwards indicating an increasing trend, horizontal indicating a steady state, and downwards indicating a decreasing trend.

In yet another aspect, the trend indicator can include a color-coded background. The preferred color coded background would be red colored background would indicate an alarm condition, an amber or yellow colored background would indicate an alert condition, and a green colored background would indicate a normal operating condition.

In yet another aspect, the graphical indicator can include a graphical representation identifying the associated monitored machine condition. Examples include a thermometer representing temperature, a “V” representing velocity, and a gE representing acceleration or vibrations.

In yet another aspect, the graphical indicator can include a graphical representation in a condition where the system is unable to determine certain details associated with the identified condition. An exemplary graphical representation in a condition where the system is unable to determine certain details associated with the identified condition is a question mark.

In regards to a functional embodiment of the system, the functional embodiment comprises a series of steps, including:

installing a radio frequency identification (RFID) transponder into a machine, wherein the RFID transponder includes:
a radio frequency identification (RFID) antenna,
a radio frequency identification (RFID) transmitter in signal communication with the RFID antenna,
a radio frequency identification (RFID) receiver in signal communication with the RFID antenna,
a digital memory element including a series of memory blocks established for retaining historic measurements,
a microprocessor in signal communication with and operational control of the digital memory element, the RFID transmitter and the RFID receiver;

removably coupling a machine condition advisor (MCA) to the machine, the MCA comprising a sensor input and a microprocessor, wherein the microprocessor operates in accordance with a series of machine condition instructions;

obtaining machine condition data through the MCA;

transferring the obtained machine condition data to the historic measurements memory blocks; and

analyzing the machine condition data stored in the historic measurements memory blocks to determine machine condition trends.

In a second method aspect, the functional embodiment further comprises a step of informing a service technician of the determined machine condition trends.

In another aspect, the step of informing a service technician of the determined machine condition trends is provided using at least one graphical representation.

In yet another aspect, the historical data stored within the historic measurements memory blocks can be updated based upon a manual command entered into the MCA or based upon any predetermined criteria established within the MCA. The updating process would preferably utilize a first in-first out transition process, wherein as each new data point is entered into the historic measurements memory blocks, the oldest data point is deleted.

In yet another aspect, the functional embodiment further comprises a step of establishing machine location information in a location identifier section of the RFID transponder digital memory element.

In yet another aspect, the functional embodiment further comprises a step of establishing machine related set up information in a setup memory section of the RFID transponder digital memory element.

The integration of an RFID transponder into a machine conditioning system provides several advantages over the currently used rout based inspection programs. As presented in the background, route based inspection programs introduce a variety of limitations. The introduction of RFID transponders into the machine condition monitoring system enables wireless near field communication between the RFID transponder and an associated RFID reader. This reduces time for a technician to collect machine condition data.

The integration of the RFID transponder introduces a digital memory element. The RFID transponder digital memory element can be configured to retain historical data points enabling analysis of the machine condition to determine trends. The RFID transponder digital memory element introduces a low cost solution for integration of a memory device and a data analysis processing system into a real time solution located at each monitored machine.

These and other features, aspects, and advantages of the invention will be further understood and appreciated by those skilled in the art by reference to the following written specification, claims and appended drawings, which follow.

### BRIEF DESCRIPTION OF THE DRAWINGS

For a fuller understanding of the nature of the present invention, reference should be made to the accompanying drawings in which:

FIG. 1 presents a schematic diagram representative of a route based machine inspection process;

FIG. 2 presents a schematic diagram representative of a radio frequency identification (RFID) system detailing components of a RFID transponder and a RFID reader and an associated communication interface therebetween;

FIG. 3 presents an top view of an exemplary machine condition advisor (MCA);

FIG. 4 presents an elevation view of a RFID transponder mounted to a machine, wherein the RFID transponder is employed to collect and maintain machine related information, including historical machine condition data;

FIG. 5 presents the elevation view previously presented in FIG. 4, introducing an interaction between the MCA and the RFID transponder;

FIG. 6 presents the configuration of the elevation view previously presented in FIG. 5, introducing a current quantitative and trending graphical output;

FIG. 7 presents the configuration of the elevation view previously presented in FIG. 5, introducing a step of incrementing data within a series of stored historical machine condition data;

FIG. 8 presents a flow diagram detailing an exemplary machine condition monitoring process;

FIG. 9 presents a schematic diagram detailing an exemplary machine condition advisor operational schematic;

FIG. 10 presents a series of exemplary machine condition trend graphical depictions;

FIG. 11 presents an exemplary data mapping arrangement of a point setup memory block of the RFID transponder digital memory element; and

FIG. 12 presents an exemplary data mapping arrangement of an exemplary historical machine condition measurements memory block of the RFID transponder digital memory element.

Like reference numerals refer to like parts throughout the several views of the drawings.

### DETAILED DESCRIPTION OF REPRESENTATIVE EMBODIMENTS

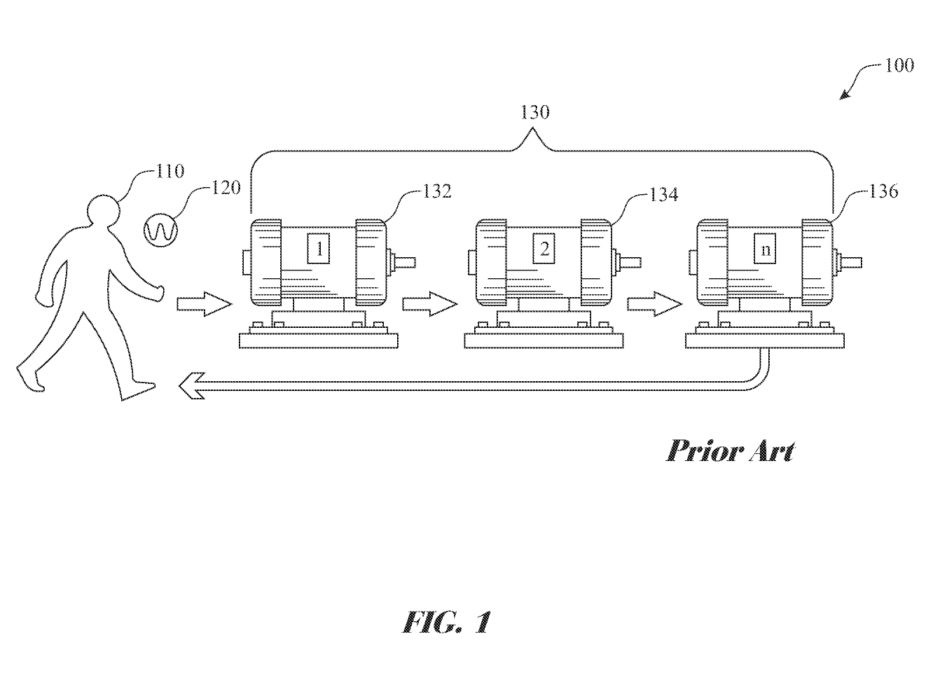

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

On line monitoring systems are expensive to install and maintain. Typically, many facilities utilize offline machine condition monitoring processes; more specifically, they rely upon their engineers to utilize a route based procedure for inspecting and maintaining the machines. The exemplary route based system 100 has been historically utilized for monitoring a series of machines 130, as shown in the exemplary illustration presented in FIG. 1. The data collection technician 110 would utilize a machine condition detector 120 for obtaining machine condition data from each of the series of monitored machines 130. The data collection technician 110 would temporarily affix the machine condition detector 120 to each respective machine 132, 134, 136 and wait until the machine condition detector 120 obtains and records the conditions. The data collection technician 110 would have to enter machine identification information to associate each respective machine 132, 134, 136 with the obtained set of machine condition data. The collected information is subsequently transferred from the machine condition detector 120 to a data collection host for analysis and archiving of the collected machine condition data. This process is time consuming and includes an inherent lag time for data collection and processing.

Alternatively, storing machine condition data at the machine would introduce a number of benefits. The system can complete analysis locally to determine when the machine encounters an operating condition that may introduce a concern for the operating health of the machine. By collecting historical condition data, the system can additionally determine and present trends of each machine condition. The utilization of machine condition trends introduces a new benefit for the engineers and maintenance personal, where they can use the trends to proactively predict, determine, and schedule necessary maintenance, thus minimizing machine downtime.

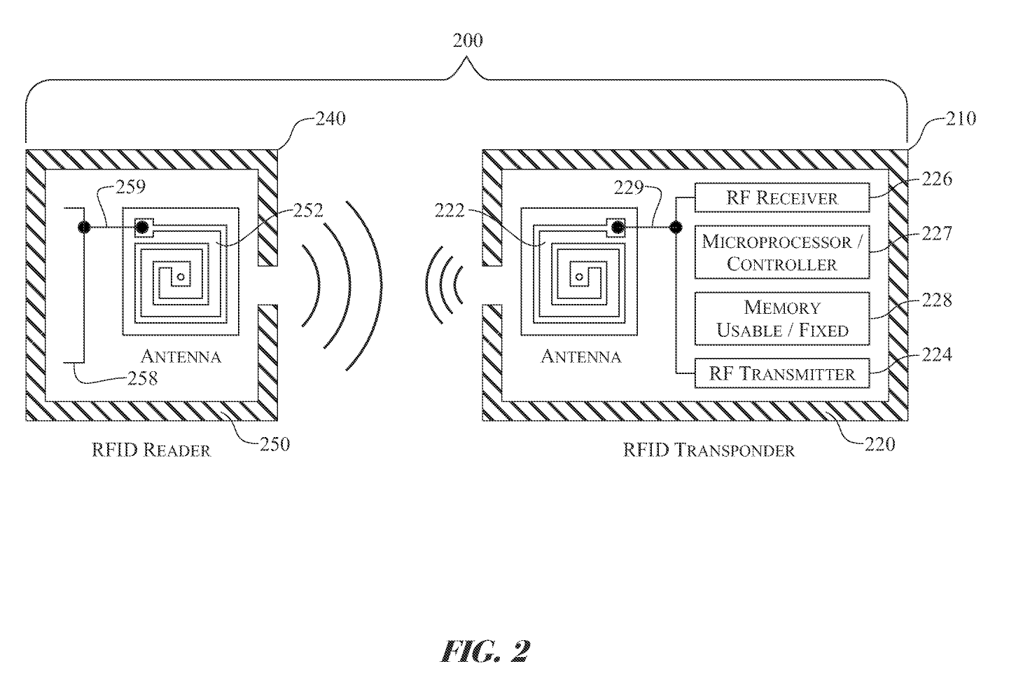

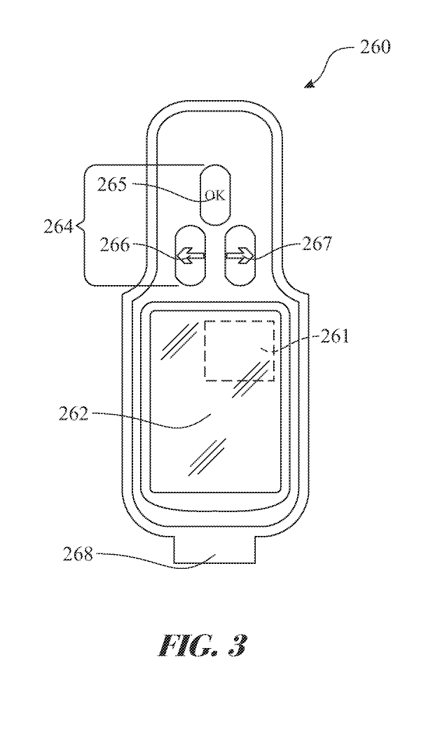

Components and operation of a radio frequency identification (RFID) communication system 200 is presented in the exemplary schematic diagram shown in FIG. 2. The radio frequency identification (RFID) communication system 200 employs a radio frequency identification (RFID) transponder 210 and a RFID reader 240 for providing wireless communication between each of two devices. The RFID transponder 210 and radio frequency identification (RFID) reader 240 include paired antenna, a RFID transponder antenna 222 and a RFID receiver antenna 252, respectively for communicating with one another using passive near field communication technology. The RFID transponder 210 includes a RFID transponder processor/controller 227, which provides intelligence and operational control to the RFID transponder 210. Data and instruction sets are stored within a RFID transponder digital memory 228. The RFID transponder digital memory 228 is provided in signal communication with the RFID transponder processor/controller 227, preferably being integrated into a single device or alternatively being integrated into to a printed circuit assembly. The RFID transponder digital memory 228 can be configured for storage of specific information in accordance with a pre-established index. Details of an exemplary storage configuration is described later herein. Communication is provided by a RFID transponder transmitter circuit 224 and a RFID transponder receiver circuit 226. The RFID transponder transmitter circuit 224 provides outbound communications through the RFID transponder antenna 222 as directed by the RFID transponder processor/controller 227. The RFID transponder receiver circuit 226 provides inbound communications through the RFID transponder antenna 222 and forward the received signal to the RFID transponder processor/controller 227 for subsequent processing. Communication between the RFID transponder antenna 222 and each of the RFID transponder transmitter circuit 224 and RFID transponder receiver circuit 226 is provided by a transponder antenna communication link 229. The elements of the RFID transponder 210 are integrated into a RFID transponder enclosure 220, creating a single assembly. Similarly, the elements of the RFID reader 240 are integrated into a RFID reader enclosure 250, creating a single portable assembly.

The basic concept is that an RFID reader 240 transmits a short pulse of electromagnetic energy. This pulse is received by the RFID transponder 210 and demodulated. Some of the energy of the received pulse is used as a transient power source. This power is then used to energize the internal circuitry of the transponder, allowing any data in the transmitted pulse to be decoded and used to determine what subsequent data should be returned to the RFID reader 240 by way of a secondary pulse, transmitted from the RFID transponder 210 back to the RFID reader 240. The functionality of the RFID transponder 210 and the detectable range of the transmitted pulse are determined by the radio frequency chosen. The lower the frequency, the slower the data bandwidth, and the greater the amount of energy that will be required to keep the transponder energized during the data read\write cycle.

The RFID receiver antenna 252 receives the signal emitted from the RFID transponder antenna 222. The signal from the RFID transponder antenna 222 excites the RFID receiver antenna 252 generating a current. The current can pass through the RFID receiver antenna 252 and into a circuit, such as a RFID reader circuitry 258, through a reader antenna communication link 259. The RFID reader circuitry 258 can include circuitry to embed data into a signal. The data embedded signal is then broadcast by the current flowing through the RFID receiver antenna 252 and received by the RFID transponder antenna 222. This provides a low cost, low power, bi-directional communication link between the RFID transponder 210 and the RFID reader 240.

Integration of the radio frequency identification (RFID) communication system 200 into a machine condition monitoring system offers a number of benefits. Initially, the RFID transponder 210 enables wireless communication with other compatible wireless, near field enabled devices. The digital memory element of the RFID transponder 210 enables data collection and management at a very low cost. The integration of the various components into a single assembly forming the RFID transponder 210 enables simple installation.

The radio frequency identification (RFID) communication system 200 introduces one portion of the necessary equipment. A machine condition advisor (MCA) 260 introduces a second component into the system. The machine condition advisor (MCA) 260 includes a microprocessor 261, which provides operation control and management of the machine condition advisor (MCA) 260. The microprocessor 261 would be in signal communication a condition sensor input 268. The condition sensor input 268 would provide sensor communication between the machine condition advisor (MCA) 260 and the associated machine 132, 134, 136. Information is presented to the user on a machine condition advisor (MCA) display panel 262. A machine condition advisor (MCA) user input interface 264 provides an element for user entry. The exemplary MCA user input interface 264 includes a series of three entry keys: an acceptance user entry key 265, a left user entry key 266, and a right user entry key 267. Although the exemplary MCA user input interface 264 includes a series of entry keys, it is understood that the MCA user input interface 264 can include any number of keys and/or any other suitable user input device. One alternative user input interface can be integrating a touch screen as the MCA display panel 262. The microprocessor 261 is representative of an operational circuit and can include digital memory, power regulators, a portable power supply, and the any other element required for operation of the device. A series of instructions, such as software would be programmed into the microprocessor 261. The set of instructions would provide any suitable solution, including those, which will be described herein.

The RFID transponder 210 is securely fastened to a machine 300 as illustrated in FIGS. 4 through 7. The RFID transponder 210 is preferably securely fastened to those parts of the machine 300 which require regular inspection. Typically these will include the Drive End (DE) or Non Drive End (NDE) bearing housings of a machine, or even the casing or mounting assembly of the machine itself.

The RFID transponder 210 can be affixed using any suitable attachment method, including adhesive, adhesive tape, a bonding agent, threaded fasteners, mechanical fasteners, and the like. A machine condition advisor (MCA) electromechanical coupler 302 is assembled or integrated into the machine 300. The MCA electromechanical coupler 302 provides several functions. Initially, the MCA electromechanical coupler 302 provides an element for mechanically attaching the machine condition advisor (MCA) 260 to the machine 300. The MCA electromechanical coupler 302 provides thermal transfer from the machine 300 to the machine condition advisor (MCA) 260. The MCA electromechanical coupler 302 provides vibrational transfer from the machine 300 to the machine condition advisor (MCA) 260. The MCA electromechanical coupler 302 provides acceleration transfer from the machine 300 to the machine condition advisor (MCA) 260. The MCA electromechanical coupler 302 is commonly provided as a mounting stud. It is also understood that any suitable or desired sensor can be located upon the machine 300 and connected to the machine condition advisor (MCA) 260 to obtain additional machine condition indicative data.

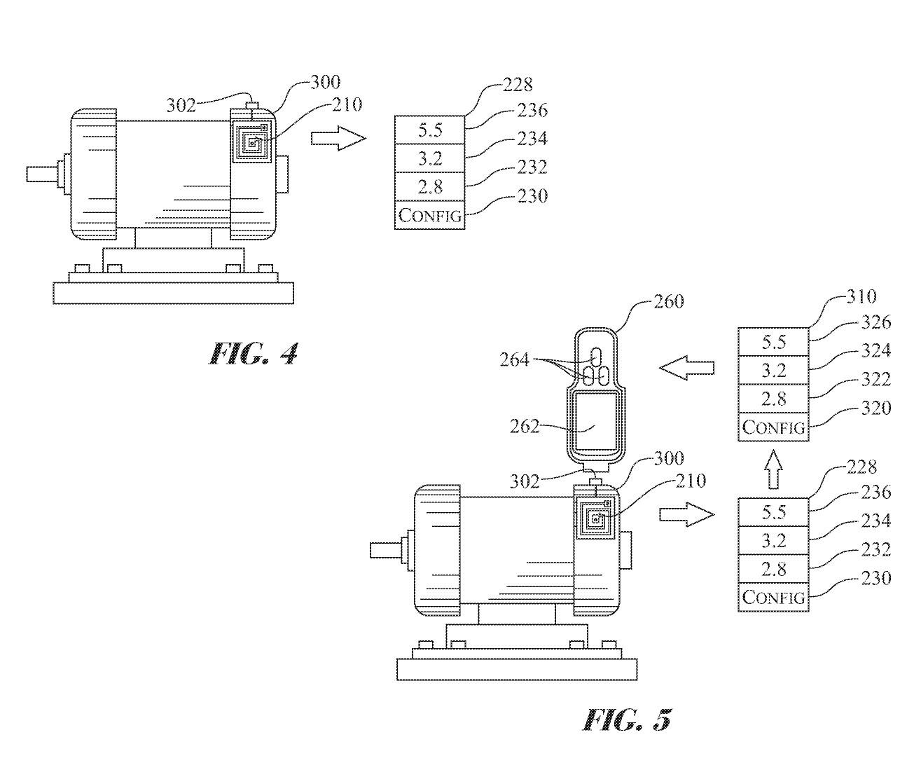

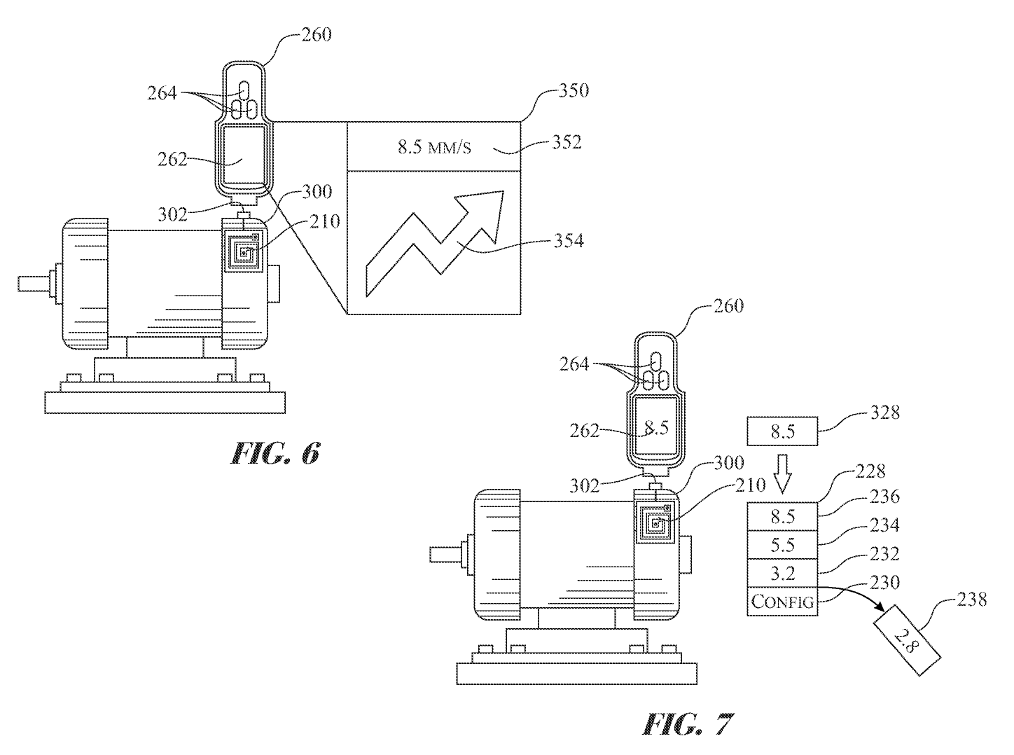

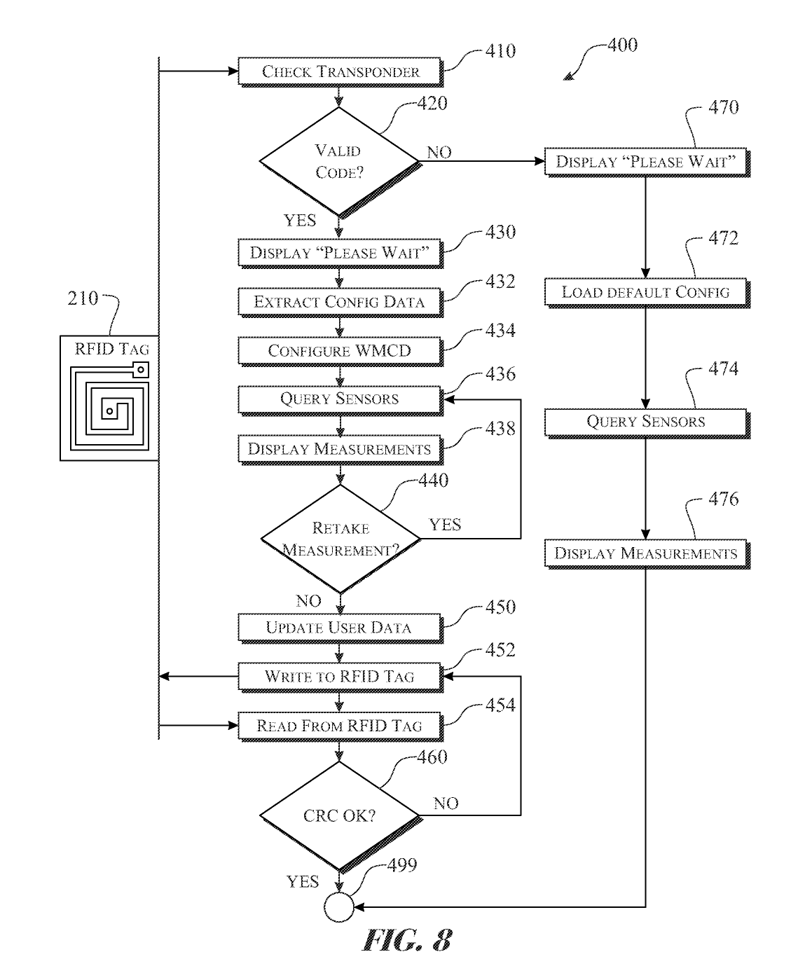

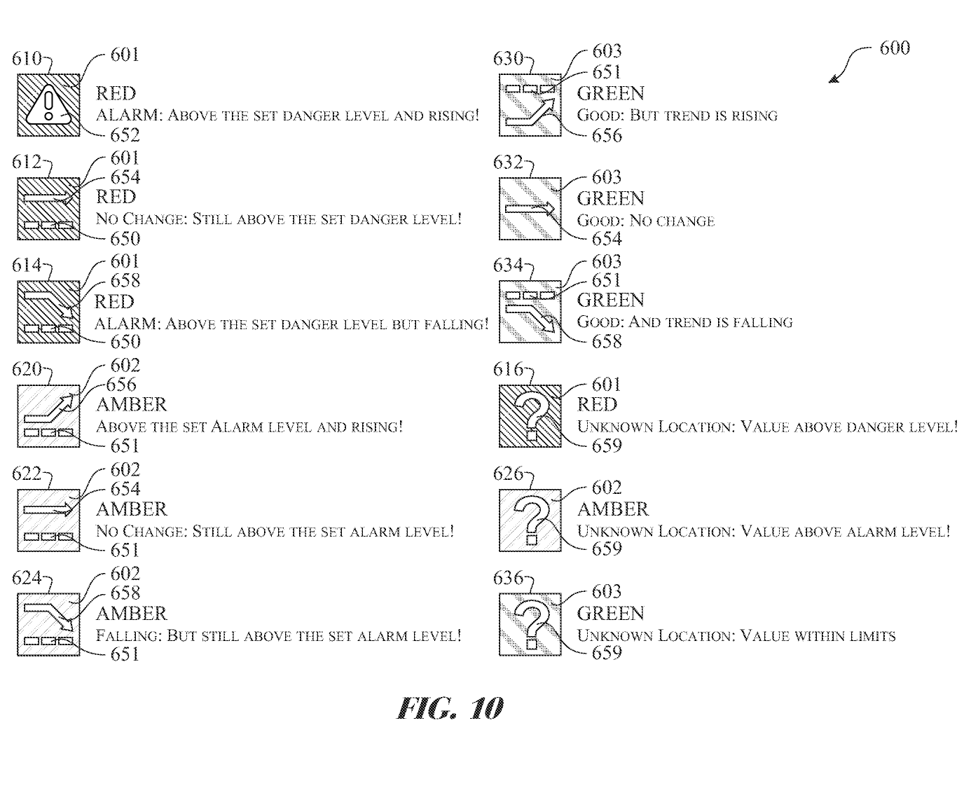

The RFID transponder 210 is initially programmed by transferring pre-established data, more specifically, a RFID transponder configuration profile 230 into a configuration block. Initially, the RFID transponder 210 is configured by establishing a series of memory data blocks 322, 324, 326 for dedicated for recording and retaining historical machine condition data, wherein the series of memory data blocks 322, 324, 326 are a subset of a machine condition advisor (MCA) uploaded machine specific profile 310. It is also noted that the MCA uploaded machine specific profile 310 includes a machine condition advisor (MCA) configuration profile 320. The machine condition advisor (MCA) 260 queries the sensors to obtain values associated with each of the monitored machine condition criteria. As the machine condition advisor (MCA) 260 obtains each value associated with each of the monitored machine condition criteria, the value is forwarded to the RFID transponder 210 and stored in the associated memory data block 322, 324, 326. In the exemplary embodiment, a first data entry of 2.8 is determined from the sensor and subsequently recorded and stored in a first historic vibration analysis measurement data block 232. Upon a second reading, a second data entry of 3.2 is determined from the sensor and subsequently recorded and stored in a second historic vibration analysis measurement data block 234. Upon a third reading, a third data entry of 5.5 is determined from the sensor and subsequently recorded and stored in a third historic vibration analysis measurement data block 236. Each time the machine condition advisor (MCA) 260 is connected to the MCA electromechanical coupler 302, the RFID transponder 210 transfers the historical machine condition data to the memory within the machine condition advisor (MCA) 260 as illustrated in FIG. 5. The machine condition advisor (MCA) 260 can then subsequently analyze the obtained data to determine and present trends based upon the historical machine condition data. Following each sensor query, the machine condition advisor (MCA) 260 presents a machine condition data display 350 on the MCA display panel 262. The machine condition data display 350 preferably includes a current machine condition readable data 352 and a machine condition trending graphical representation 354. The current machine condition readable data 352 is a human legible quantified value, and preferably includes units as illustrated in the exemplary embodiment. The machine condition trending graphical representation 354 is a graphical representation presenting a trend determined from the recent sensor query and the uploaded historical machine condition data. Details of exemplary graphical representations are presented in FIG. 10, which presents a number of exemplary condition status indicating icons 600. Upon reading and accepting the sensor data, the machine condition advisor (MCA) 260 transfers the most recent sensor data to the RFID transponder digital memory 228, as illustrated in FIG. 7. Restated, the oldest historic measurement is dropped from the base of the stack 228, and the current measurement is added to the top of the stack 228.

In the exemplary embodiment, the current sensor value 328 is determined to be 8.5. During a historical data procedure, the oldest data value (stored in the first historic vibration analysis measurement data block 232) is discarded 238. Each of the remaining recorded data values are indexed upward into the data block designed for the previous data entry. For example, the 3.2 value stored in the second historic vibration analysis measurement data block 234 is transferred to the first historic vibration analysis measurement data block 232 upon completion of the sensor inquiry and acceptance procedure completed by the machine condition advisor (MCA) 260. The 5.5 value stored in the third historic vibration analysis measurement data block 236 is transferred to the second historic vibration analysis measurement data block 234. This leaves the third historic vibration analysis measurement data block 236 available for receiving the value of the replacement historic vibration analysis measurement 328.

By storing the historical data in the RFID transponder 210, the process is significantly simplified and enables the data collection technician 110 to use a lower cost and less complex machine condition advisor (MCA) 260, as the data collection technician 110 does not have to transfer historical data from a server or other host to the machine condition advisor (MCA) 260 prior to completing any inspections of the machines 300. The historical data recorded in the RFID transponder digital memory 228 of the RFID transponder 210 provides precise and recent data specific to that machine 300.

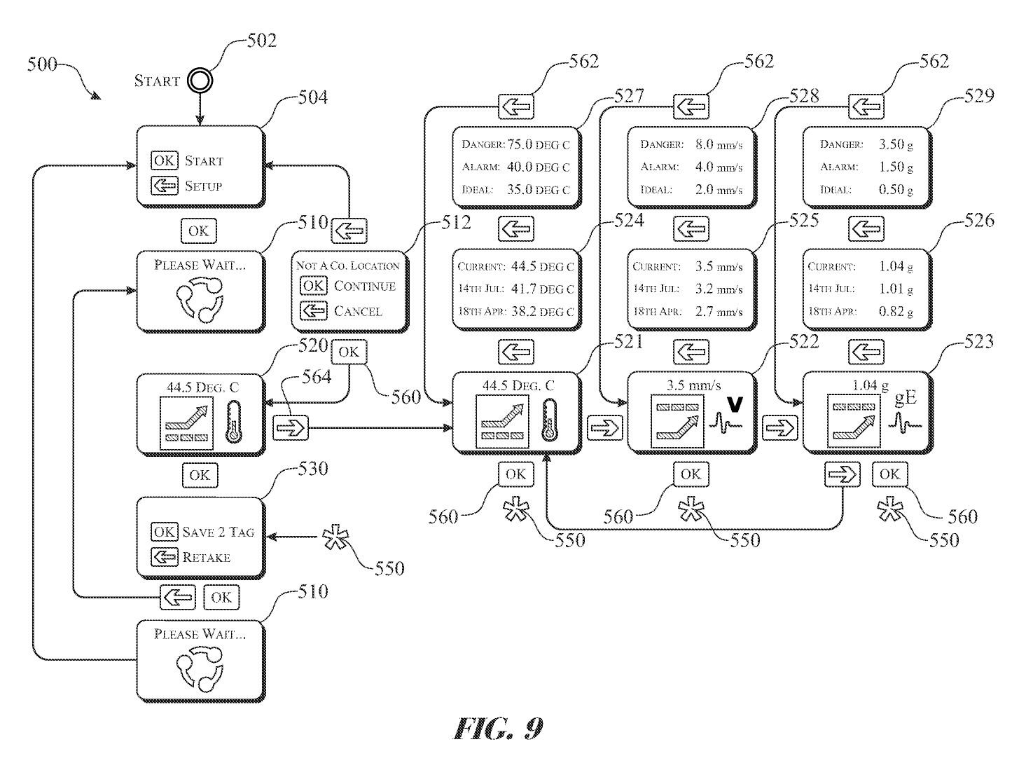

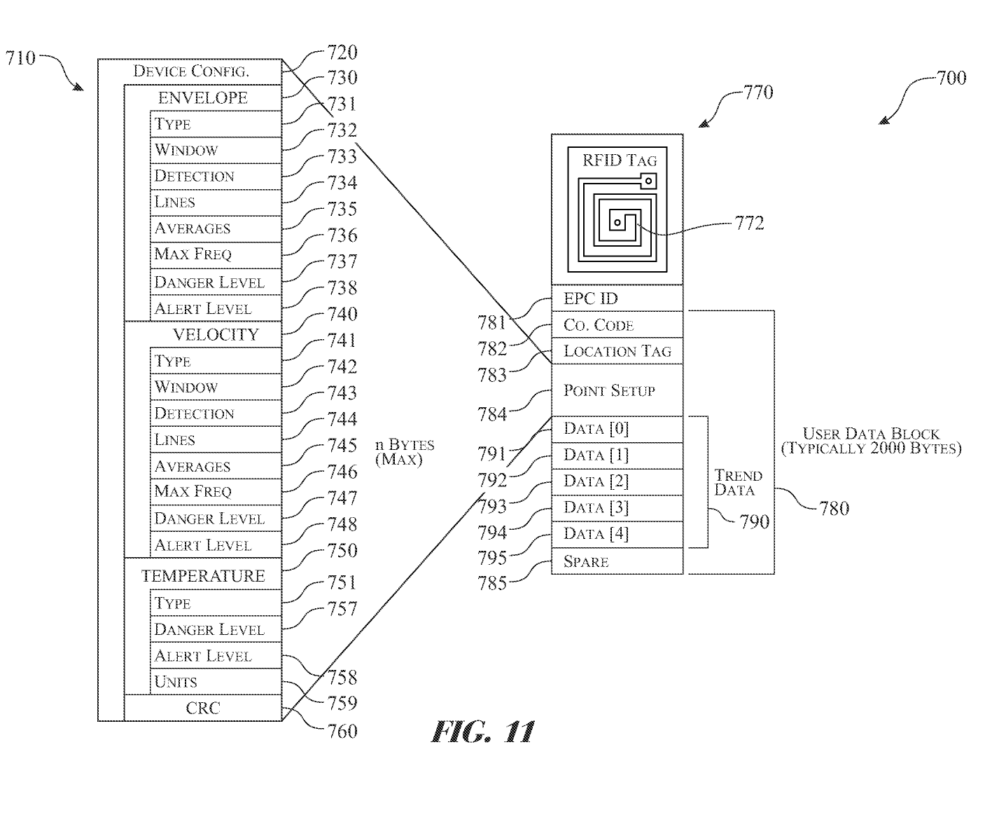

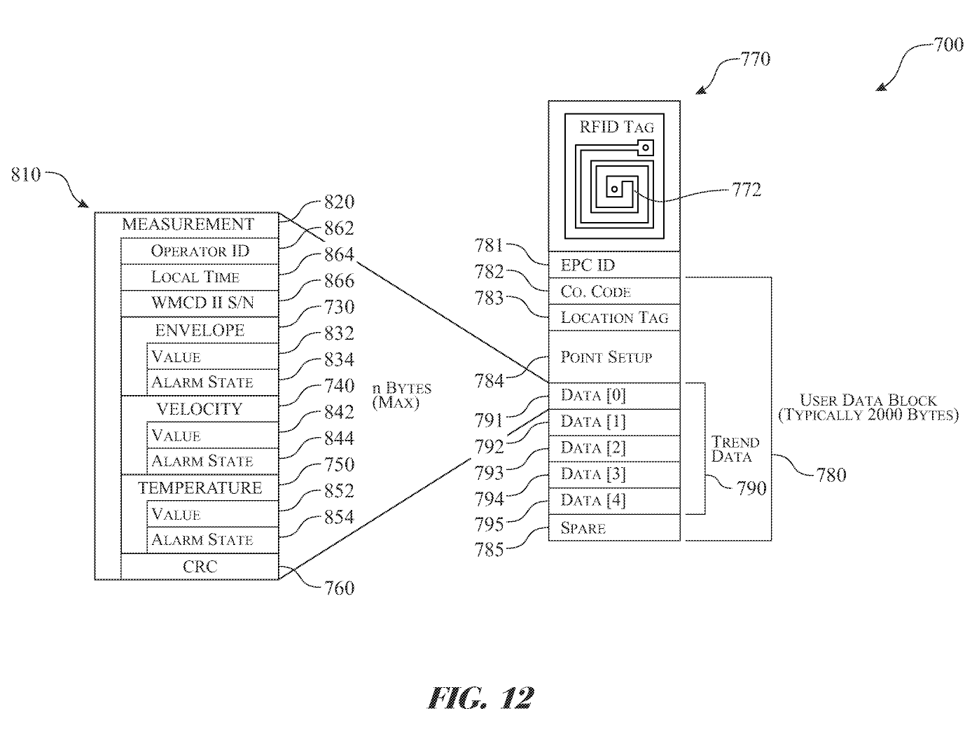

An exemplary machine condition monitoring process 400 is presented in FIG. 8, wherein the exemplary machine condition monitoring process 400 describes a more detailed overview of the overall process. In initially, the machine condition advisor (MCA) 260 is placed upon the machine 300 in a manner enabling communication with the RFID transponder 210. The machine condition advisor (MCA) 260 verifies an acceptable communication link and with and condition of the RFID transponder 210 (block 410). The RFID transponder 210 can be programmed with a company specific identification code to determine compatibility with the system (decision block 420). This can be completed using any suitable identification code format. In the exemplary embodiment (with reference to the exemplary configuration of user data blocks 780 (FIGS. 11 and 12), a company code identifier 782 is 32 byte fixed identifier. The company code identifier 782 conveys that the specific RFID transponder 210 has a configuration that is compatible with the anticipated configuration, consistent with the employed system. Upon validation that the configuration of the RFID transponder 210 is compatible with the employed system, the system initiates a query of the various sensors. This process may take some time. During the cycle time for preparing and processing the sensor query, the machine condition advisor (MCA) 260 would display a message indicating that the system is cycling and that the operator should patiently wait (block 430). The communication initiates by extracting the configuration data associated with the machine 300 and associated RFID transponder 210 (block 432). The configuration data obtained from the RFID transponder 210 is used to configure the machine condition advisor (MCA) 260 (block 434). The wireless machine condition detector (WMCD) can be integrated into the machine condition advisor (MCA) 260 or provided as a separate unit. The machine condition advisor (MCA) 260 queries each of the sensors to obtain current machine condition measurements (block 436). The current machine condition measurements are presented on the MCA display panel 262 (block 438). The operator reviews the current machine condition measurements displayed and considers whether to accept to retake one or more measurements (decision block 440). In a condition where the operator determines that at least one or more measurements should be retaken, the process returns to the step of querying each of the sensors to obtain current machine condition measurements (block 436). In a condition where the operator determines that the obtained measurements are acceptable, the process continues and updates the user data information in the machine condition advisor (MCA) 260 (block 450). The updated information is forward to the RFID transponder 210 and written to the RFID transponder digital memory 228 of the RFID transponder 210 (block 452).

Assuming a valid Transponder Code, then once the machine condition advisor (MCA) 260 has finished recording data from the machine contact point or MCA electromechanical coupler 302, the machine condition advisor (MCA) 260 compares the current values against those that were previously recorded, and determines for each sensor value what the statistical change for each is (for example: “slow rise towards alarm”, “slow fall to normal”, “rapid rise towards alarm but not actually in alarm”, etc.) Once the trending statistics for each sensor has been calculated, the worst trending statistic of the three is displayed on the MCA display panel 262.

The writing process is validated (in accordance with a cyclic redundancy check (CRC) by reading the information from the RFID transponder digital memory 228 (block 454) and comparing the read information stored within the machine condition advisor (MCA) 260 (block 460). If the cyclic redundancy check (CRC) determines the written data is inaccurate, the process returns to the step of forwarding updated information to the RFID transponder 210 and writing the forwarded information to the RFID transponder digital memory 228 of the RFID transponder 210 (block 452). If the cyclic redundancy check (CRC) determines the written data is accurate, the process terminates (block 499).

Returning to the step of determining the compatibility of the RFID transponder 210 with the system (decision block 420), should the process determine that the RFID transponder 210 is configured for a different system, the process continues by uploading a standard default configuration (block 472). The machine condition advisor (MCA) 260 would inform the operator that a delay could be encountered (block 470) during this time. The machine condition advisor (MCA) 260 queries the various sensors (block 474). The machine condition advisor (MCA) 260 displays the measurements obtained from the sensors (block 476). The process terminates at this point, as the configuration of the RFID transponder 210 is unknown. In a condition where the RFID transponder 210 is configured for a different system, the cyclic redundancy check (CRC) is not validated, or any other suspect condition is identified, the machine condition advisor (MCA) 260 will not attempt to write measured sensor values back to the RFID transponder 210. In this scenario, instead of displaying a trending graphical image, the system will display an exception graphic alongside the returned measurement. This unique feature ensures that only those RFID transponders 210 configured for use with the machine condition advisor (MCA) 260 can actually be written to, thereby preventing accidental corruption of non-compatibly configured RFID transponders 210.

The machine condition advisor (MCA) 260 includes a variety of options for the user to step through a process for reviewing each of the sensor measurements, historical data for each of the machine condition measurements, and each of the machine condition warning set points. An exemplary mapping or machine condition advisor operational schematic 500 is presented in FIG. 9. The operator couples the machine condition advisor (MCA) 260 to the machine 300 and connecting any sensors accordingly. Once the machine condition advisor (MCA) 260 is properly mounted to the machine 300, the operator activates the machine condition advisor (MCA) 260 (block 502). The microprocessor 261 initiates with a query to the operator on whether the operator desires to start querying sensors or complete an initial set up routine. The operator selects the acceptance user entry key 265 to create a right entry key selection 564. The machine condition advisor (MCA) 260 queries the RFID transponder 210 to determine if the configuration of the RFID transponder 210 is compatible with the configuration of the specific system being used. During this query, the microprocessor 261 can optionally display a pending notice to inform the operator that the microprocessor 261 is currently exercising a process (block 510). Should the microprocessor 261 determine that the configuration of the RFID transponder 210 is not compatible with the configuration of the machine condition advisor (MCA) 260, the microprocessor 261 informs the operator accordingly (block 512). The operator then can opt to cancel the query by providing a left entry key selection 562. Alternatively, the operator can elect to proceed with simply querying the sensors, while understanding the benefits may be limited. In a condition where the microprocessor 261 determines that the configuration of the RFID transponder 210 is compatible with the configuration of the machine condition advisor (MCA) 260, the process simply proceeds forward. The microprocessor 261 initiates a query of each of the machine condition sensors to obtain machine condition measurements (block 520). Upon completion of the query, the microprocessor 261 displays an initial sensor output. The initial sensor output can include a human legible quantified value, and preferably includes units as illustrated in the exemplary embodiment, and a graphical representation presenting a trend determined from the recent sensor query and the uploaded historical machine condition data. The display can additionally include a graphical representation of the measurement category. Exemplary graphical representations of the measurement categories include a thermometer representative of temperature, a “V” being representative of velocity, and “gE” being representative of acceleration for shock. Upon completion of the query, the operator can step through the various machine condition measurements, their associated history, and their associate pre-determined warning levels. The operator would submit a right entry key selection 564 to initiate a sensor measurements review process. The operator would step through each of the sensor measurements to review each current measurement, each trend of the associated machine condition, a history of measurements for each associated machine condition, and current settings provided to determine the established warning levels for each associated machine condition. The operator selects the left user entry key 266 to step between one specific machine condition measurement and trend data 521, 522, 523, associated history of measurements for the respective machine condition 524, 525, 526, and associate pre-determined warning levels for each machine condition 527, 528, 529. Conversely, the operator would select the right user entry key 267 to select a different machine condition to be reviewed. In the exemplary embodiment. A matrix describing the exemplary machine condition data summary is presented below:

Machine Condition Data Summary Screen Index

| | Temperature | Velocity | Acceleration |
|---|---|---|---|
| | Measurements | Measurements | Measurements |
| Alarm Warning Limits | Screen 527 | Screen 528 | Screen 529 |
| Historical | Screen 524 | Screen 525 | Screen 526 |
| Measurements | | | |
| Current & Trending | Screen 521 | Screen 522 | Screen 523 |
| Data | | | |

After reviewing each or all of the machine condition measurements, the operator would select the acceptance user entry key 265, sending an OK/accept button selection 560 to the microprocessor 261. This directs the microprocessor 261 to a machine condition measurement consideration decision window 530. It is noted that a process link 550 references a link from the machine condition data review portion of the process to the machine condition measurement consideration decision window 530 portion of the process. The user can select the OK/accept button selection 560 at any point within the machine condition measurements review portion of the process to jump to the machine condition measurement consideration decision window 530. The operator determines if the collected measurement data is accurate or inaccurate. In a condition where the operator determines at least one of the measurements is inaccurate, the operator can select the left user entry key 266, sending a left entry key selection 562 to the microprocessor 261. This directs the microprocessor 261 to re-initiate a query to one or more sensors to obtain replacement sensor measurement data. In a condition where the operator determines that all of the measurements (or the selected measurement) are accurate, the user would select the acceptance user entry key 265, sending an OK/accept button selection 560 to the microprocessor 261. The OK/accept button selection 560 the microprocessor 261 to save the current measurement to the data location in the RFID transponder digital memory 228 associated with the most recent measurements. In a situation where the operator wants to return to the machine condition data review portion of the process, the operator would select the right user entry key 267, sending a right entry key selection 564 to the microprocessor 261. This would direct the microprocessor 261 to return to the machine condition data review portion of the process. The microprocessor 261 would display a processing time notification 510 at any point where the microprocessor 261 is completing a process that requires any noticeable amount of time to inform the operator that the microprocessor 261 is currently undergoing processing.

Each machine condition output can include a graphical representation indicative of the status of the machine condition as illustrated in the condition status indicating icons 600 presented in FIG. 10. Each machine condition would be associated with two alert levels: one for identifying an alarm condition and a second identifying a danger condition. Each machine trend indicator 610, 612, 614, 616, 620, 622, 624, 626, 630, 632, 634, 636 include a color coded background 601, 602, 603 and a graphical representation to quickly and easily convey a trend status of each associated machine condition to a technician, an operator, a service person, an Engineer, and the like. The color coding is consistent with commonly associated colors: a red icon background 601, which indicates a dangerous machine condition level; an amber icon background 602, which indicates an alarming machine condition level, and a green icon background 603, which indicates an acceptable or normal operating condition. Graphical representations or indicators are inserted within the backgrounds to convey more details to the machine operator. A majority of the exemplary graphical representation indicators include arrows and either a danger limit reference symbol 650 (for the danger condition indicators) or an alarm limit reference symbol 651 (for the alarm or acceptable condition indicators). The alert reference lines 650, 651 provide references for a relationship of the alert setting. In a portion of the trending danger condition indicators 612, 614, the graphical arrow indicators would be placed above the danger limit reference symbol 650 indicating that the condition is above the established danger level.

Describing the graphical indicators that are indicative of a condition where the machine is operating with a dangerous machine condition. In a worst case condition, identified as an alarm condition indicator with rising condition trend 610, the graphical representation can be a rising trend indicating symbol 656 positioned above the danger limit reference symbol 650 (not shown), or, to ensure the operator is aware of the extreme danger condition (and getting worse), the graphical representation can display a dangerous condition symbol 652 (as shown). Either graphical image would be superimposed over the red icon background 601. The dangerous condition symbol 652 would be a unique symbol to ensure that the operator is advised of the severity of the machine condition. An alarm condition indicator with steady state trend 612 is slightly less concerning than the alarm condition indicator with rising condition trend 610, where the alarm condition indicator with steady state trend 612 is presented having a steady state indicating symbol 654 located above the danger limit reference symbol 650, with the graphical representation being shown upon the red icon background 601. The alarm condition indicator with steady state trend 612 indicates that the machine condition is remaining at a steady state and not increasing beyond the established danger level. An alarm condition indicator with falling condition trend 614 is slightly less concerning than the alarm condition indicator with steady state trend 612, where the alarm condition indicator with falling condition trend 614 is presented having a falling trend indicating symbol 658 located above the danger limit reference symbol 650, with the graphical representation being shown upon the red icon background 601. The alarm condition indicator with falling condition trend 614 indicates that the machine condition is trending downward, closer to the established danger level. In a situation where the specific machine characteristic is unknown, the system can display an alarm condition indicator at an unknown location 616, which would present an unknown location indicating symbol 659 over a red icon background 601.

Describing the graphical indicators that are indicative of a condition where the machine is operating with an alarm machine condition, but below what could be interpreted as a dangerous machine condition. In a worst case alarm condition, identified as an alert condition indicator with rising condition trend 620, the graphical representation can be a rising trend indicating symbol 656 positioned above the alarm limit reference symbol 651. The graphical images would be superimposed over the amber icon background 602. An alert condition indicator with steady state trend 622 is slightly less concerning than the alert condition indicator with rising condition trend 620, where the alert condition indicator with steady state trend 622 is presented having a steady state indicating symbol 654 located above the alarm limit reference symbol 651, with the graphical representation being shown upon the amber icon background 602. The alert condition indicator with steady state trend 622 indicates that the machine condition is remaining at a steady state and not increasing beyond the established alarm level. An alert condition indicator with falling condition trend 624 is slightly less concerning than the alert condition indicator with steady state trend 622, where the alert condition indicator with falling condition trend 624 is presented having a falling trend indicating symbol 658 located above the alarm limit reference symbol 651, with the graphical representation being shown upon the amber icon background 602. The alert condition indicator with falling condition trend 624 indicates that the machine condition is trending downward, closer to the established alarm level and could trend into an acceptable range. In a situation where the specific machine characteristic is unknown, the system can display an alert condition indicator an unknown location 626, which would present an unknown location indicating symbol 659 over an amber icon background 602.

Describing the graphical indicators that are indicative of a condition where the machine is operating with an acceptable machine condition. In a worst case acceptable condition, identified as a normal condition indicator with rising condition trend 630, the graphical representation can be a rising trend indicating symbol 656 positioned below the alarm limit reference symbol 651. The graphical images would be superimposed over the green icon background 603. The normal condition indicator with rising condition trend 630 indicates that the machine condition is trending towards passing the established alarm level. In this condition, the operator may consider increasing the frequency of monitoring the associated machine condition more frequently. A normal condition indicator with steady state trend 632 is slightly less concerning than the normal condition indicator with rising condition trend 630, where the normal condition indicator with steady state trend 632 is presented having a steady state indicating symbol 654 located below the alarm limit reference symbol 651, with the graphical representation being shown upon the green icon background 603. The normal condition indicator with steady state trend 632 indicates that the machine condition is remaining at a steady state and not increasing towards the established alarm level. A normal condition indicator with calling condition trend 634 is even less concerning than the normal condition indicator with steady state trend 632, where the normal condition indicator with calling condition trend 634 is presented having a falling trend indicating symbol 658 located below the alarm limit reference symbol 651, with the graphical representation being shown upon the green icon background 603. The normal condition indicator with calling condition trend 634 indicates that the machine condition is trending downward, further away from the established alarm level and will continue to trend in an acceptable range. In a situation where the specific machine characteristic is unknown, the system can display a normal condition indicator an unknown location 636, which would present an unknown location indicating symbol 659 over a green icon background 603.

A RFID transponder monitor system 700, presented in FIGS. 11 and 12, details an exemplary data mapping of a RFID transponder system 770, where the RFID transponder system 770 is exemplary of the RFID transponder 210. An exemplary machine condition advisor (MCA) data structure 710 is detailed in FIG. 11 and an exemplary trend data series 810 is detailed in FIG. 12. The RFID transponder system 770 includes a RFID transceiver 772, which is analogous to the RFID transponder antenna 222. The data banks are preferably stored in the RFID transponder digital memory 228. The data banks can be segmented into three primary categories: an electronic product code (EPC) identifier 781, a user data block 780, and a trend data storage banks 790, with the trend data storage banks 790 being a subset of the user data blocks 780.

The trend data storage banks 790 are established to record and maintain historical machine condition measurements and the associated dates when the measurements were obtained. The exemplary embodiment includes a series of five (5) historical machine condition measurement data arrays 791, 792, 793, 794, 795. Additional memory blocks established within the user data blocks 780 include a company code identifier 782, a location identifier 783, a point setup data series 784, and a spare data bank 785. The company code identifier 782 identifies if the configuration of the RFID transponder 210 is compatible with the system utilized by the service technician. The location identifier 783 references a location of the associated machine 300. The point setup data series 784 establishes a memory bank (mapped as a machine condition advisor (MCA) data structure 710) for configuration data associated with each of the respective sensor categories. The spare data bank 785 provides availability of additional memory for storage of any unforeseen information.

The machine condition advisor (MCA) data structure 710 defines a device configuration data section 720, which is segmented into a plurality of primary categories; each category is associated with a respective sensor. An envelope data series 730 retains data associated with an acceleration or other machine condition measurement. A velocity data series 740 retains data associated with a velocity. A temperature data series 750 retains data associated with a temperature.

The envelope data series 730 includes memory slots for each of the following:

An envelope type 731,

An envelope window 732,

An envelope detection 733,

Envelope lines 734,

Envelope averages 735,

An envelope maximum frequency 736,

An envelope danger level 737, and

An envelope alert level 738.

Similarly, the velocity data series 740 includes memory slots for each of the following:

A velocity type 741,

A velocity window 742,

A velocity detection 743,

Velocity lines 744,

Velocity averages 745,

A velocity maximum frequency 746,

A velocity danger level 747, and

A velocity alert level 748.

The temperature data series 750 includes memory slots for each of the following:

A temperature type 751,

A temperature danger level 757,

A temperature alert level 758, and

A temperature unit 759.

The device configuration data section 720 can additionally include a cyclic redundancy check (CRC) 760, wherein the cyclic redundancy check (CRC) 760 is utilized for validation of data transfer from an external data source (such as a data transfer from the machine condition advisor (MCA) 260 to the RFID transponder 210). The cyclic redundancy check (CRC) 760 would be determined based upon known CRC processes.

Each trend data series 791, 792, 793, 794, 795 includes one historical series of data 810. The exemplary trend data series 810 records a series of measurements 820 associated with a specific accepted sensor query session. A portion of the series of measurements 820 records processing information, including:

An operator identification (ID) 862,

A local time 864 when the data was acquired, and

A wireless machine condition data serial number 866.

The series of measurements 820 additionally includes a machine condition measured value 832, 842, 852 and an alarm state 834, 844, 854 for each machine condition measured. In the exemplary embodiment, the process queries sensors to determine envelope data 730, velocity data 740, and temperature data 750. More specifically, the envelope data 730 includes an envelope value 832 and an envelope alarm status 834; the velocity data 740 includes a velocity value 842 and a velocity alarm status 844; and the temperature data 750 includes a temperature value 852 and a temperature alarm status 854.

The exemplary trend data series 810 is configured for five (5) historical sensor query sessions, whereas the exemplary RFID transponder digital memory 228 demonstrated a configuration for three (3) historical sensor query sessions. Adapting the exemplary trend data series 810 to the exemplary RFID transponder digital memory 228 would parallel a historical series of data [2] 793 is associated with the first historic vibration analysis measurement data block 232; a historical series of data [1] 792 is associated with the second historic vibration analysis measurement data block 234; and a historical series of data [0] 791 is associated with the most recent historic vibration analysis measurement data block 236.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

LISTING OF REFERENCE NUMBERS

| Ref. No. | Description |
|---|---|
| 100 | rotational rubber spring |
| 100 | exemplary route based system |
| 110 | data collection technician |
| 120 | machine condition detector |
| 130 | series of monitored machines |
| 132 | first monitored machine |
| 134 | second monitored machine |
| 136 | nth monitored machine |
| 200 | radio frequency identification (RFID) communication system |
| 210 | radio frequency identification (RFID) transponder |
| 220 | RFID transponder enclosure |
| 222 | RFID transponder antenna |
| 224 | RFID transponder transmitter circuit |
| 226 | RFID transponder receiver circuit |
| 227 | RFID transponder processor/controller |
| 228 | RFID transponder digital memory |
| 229 | transponder antenna communication link |
| 230 | RFID transponder configuration profile |
| 232 | first historic vibration analysis measurement data block |
| 234 | second historic vibration analysis measurement data block |
| 236 | third historic vibration analysis measurement data block |
| 238 | discarded historic vibration analysis measurement data entry |
| 240 | radio frequency identification (RFID) reader |
| 250 | RFID receiver enclosure |
| 252 | RFID receiver antenna |
| 258 | RFID reader circuitry |
| 259 | reader antenna communication link |
| 260 | machine condition advisor (MCA) |
| 261 | microprocessor |
| 262 | machine condition advisor (MCA) display panel |
| 264 | machine condition advisor (MCA) user input interface |
| 265 | acceptance user entry key |
| 266 | left user entry key |
| 267 | right user entry key |
| 268 | condition sensor input |
| 300 | machine |
| 302 | machine condition advisor (MCA) electromechanical coupler |
| 310 | machine condition advisor (MCA) uploaded machine |
| | specific profile |
| 320 | machine condition advisor (MCA) configuration profile |
| 322 | first historic vibration analysis measurement |
| 324 | second historic vibration analysis measurement |
| 326 | third historic vibration analysis measurement |
| 328 | replacement historic vibration analysis measurement |
| 350 | machine condition data display |
| 352 | current machine condition readable data |
| 354 | machine condition trending graphical representation |
| 400 | exemplary machine condition monitoring process |
| 410 | check transponder step |
| 420 | valid company code decision step |
| 430 | processing time notification |
| 432 | extract configuration data step |
| 434 | configure wireless machine condition detector (WMCD) step |
| 436 | query sensors step |
| 438 | display measurements step |
| 440 | retake measurements decision step |
| 450 | update user date step |
| 452 | write information to RFID tag step |
| 454 | read information from RFID tag step |
| 460 | cyclic redundancy check (CRC) approval decision step |
| 470 | processing time notification |
| 472 | load default configuration step |
| 474 | query sensors step |
| 476 | display measurements step |
| 499 | termination of process |
| 500 | exemplary machine condition advisor operational schematic |
| 502 | start function |
| 504 | start/setup selection |
| 510 | processing time notification |
| 512 | company specific device |
| 520 | query sensor |
| 521 | trending indication of temperature sensor data |
| 522 | trending indication of velocity sensor data |
| 523 | trending indication of vibration sensor data |
| 524 | historical temperature sensor data |
| 525 | historical velocity sensor data |
| 526 | historical vibration sensor data |
| 527 | temperature sensor alarm limits |
| 528 | velocity sensor alarm limits |
| 529 | vibration sensor alarm limits |
| 530 | machine condition measurement consideration |
| | decision window |
| 550 | process link |
| 560 | OK/accept button selection |
| 562 | left entry key selection |
| 564 | right entry key selection |
| 600 | condition status indicating icons |
| 601 | red icon background |
| 602 | amber icon background |
| 603 | green icon background |
| 610 | alarm condition indicator with rising condition trend |
| 612 | alarm condition indicator with steady state trend |
| 614 | alarm condition indicator with falling condition trend |
| 616 | alarm condition indicator at an unknown location |
| 620 | alert condition indicator with rising condition trend |
| 622 | alert condition indicator with steady state trend |
| 624 | alert condition indicator with falling condition trend |
| 626 | alert condition indicator an unknown location |
| 630 | normal condition indicator with rising condition trend |
| 632 | normal condition indicator with steady state trend |
| 634 | normal condition indicator with calling condition trend |
| 636 | normal condition indicator an unknown location |
| 650 | danger limit reference symbol |
| 651 | alarm limit reference symbol |
| 652 | dangerous condition symbol |
| 654 | steady state indicating symbol |
| 656 | rising trend indicating symbol |
| 658 | falling trend indicating symbol |
| 659 | unknown location indicating symbol |
| 700 | RFID transponder monitor system |
| 710 | exemplary machine condition advisor (MCA) data structure |
| 720 | device configuration data section |
| 730 | envelope data series |
| 731 | envelope type |
| 732 | envelope window |
| 733 | envelope detection |
| 734 | envelope lines |
| 735 | envelope averages |
| 736 | envelope maximum frequency |
| 737 | envelope danger level |
| 738 | envelope alert level |
| 740 | velocity data series |
| 741 | velocity type |
| 742 | velocity window |
| 743 | velocity detection |
| 744 | velocity lines |
| 745 | velocity averages |
| 746 | velocity maximum frequency |
| 747 | velocity danger level |
| 748 | velocity alert level |
| 750 | temperature data series |
| 751 | temperature type |
| 757 | temperature danger level |
| 758 | temperature alert level |
| 759 | temperature units |
| 760 | cyclic redundancy check (CRC) |
| 770 | RFID transponder system |
| 772 | RFID transceiver |
| 780 | user data blocks |
| 781 | electronic product code (EPC) identifier |
| 782 | company code identifier |
| 783 | location identifier |
| 784 | point setup data series |
| 785 | spare data bank |
| 790 | trend data storage banks |
| 791 | historical series of data [0] |
| 792 | historical series of data [1] |
| 793 | historical series of data [2] |
| 794 | historical series of data [3] |
| 795 | historical series of data [4] |
| 810 | exemplary trend data series |
| 820 | measurements data series |
| 862 | operator identification (ID) |
| 864 | local time |
| 866 | wireless machine condition data serial number |
| 832 | envelope value |
| 834 | envelope alarm status |
| 842 | velocity value |
| 844 | velocity alarm status |
| 852 | temperature value |
| 854 | temperature alarm status |

What is claimed is:

1. A method of monitoring a health of a machine, the method comprising steps of:
installing a radio frequency identification (RFID) transponder into a machine, wherein the RFID transponder includes:
a radio frequency identification (RFID) antenna,
a radio frequency identification (RFID) transmitter in signal communication with the RFID antenna,
a radio frequency identification (RFID) receiver in signal communication with the RFID antenna,
a digital memory element including a series of memory blocks established for retaining historic measurements,
a microprocessor in signal communication with and operational control of the digital memory element, the RFID transmitter and the RFID receiver;
removably coupling a machine condition advisor (MCA) to the machine, the MCA comprising a sensor input and a microprocessor, wherein the microprocessor operates in accordance with a series of machine condition instructions;
obtaining machine condition measurement data through the MCA; and
transferring the obtained machine condition measurement data to the historic measurement memory blocks.

2. The method of monitoring a health of a machine as recited in claim 1, the method further comprising steps of:
transferring stored historical machine condition measurements from the RFID transponder to the MCA; and
determining machine condition trending utilizing the MCA microprocessor as directed by an instruction set.

3. The method of monitoring a health of a machine as recited in claim 2, the method further comprising a step of:
informing a service technician of the determined machine condition trends.

4. The method of monitoring a health of a machine as recited in claim 2, the method further comprising a step of:
informing a service technician of the determined machine condition trends, wherein the determined machine condition trends are presented in a graphical format.

5. The method of monitoring a health of a machine as recited in claim 1, the method further comprising a step of:
associating a time when the machine condition measurement is acquired with each machine condition measurement.

6. The method of monitoring a health of a machine as recited in claim 1, the method further comprising steps of:
establishing an alert level and a danger level with each machine condition measurement; and
storing the alert level and the danger level established for each machine condition measurement in the RFID transponder.

7. The method of monitoring a health of a machine as recited in claim 6, the method further comprising steps of:
determining an operational status of the machine by comparing each machine condition measurement with each associated established alert level and danger level to determine if the machine condition is above one of the alert level and the danger level; and
conveying the operational status of the machine to an individual monitoring the machine condition.

8. The method of monitoring a health of a machine as recited in claim 1, the method further comprising a step of:
reading data stored on the RFID transponder using a radio frequency identification (RFID) reader.

9. A method of monitoring a health of a machine, the method comprising steps of:
installing a radio frequency identification (RFID) transponder into a machine, wherein the RFID transponder includes:
a radio frequency identification (RFID) antenna,
a radio frequency identification (RFID) transmitter in signal communication with the RFID antenna,
a radio frequency identification (RFID) receiver in signal communication with the RFID antenna,
a digital memory element including a memory block established for recording and retaining point setup data and a series of memory blocks established for retaining historic measurements,
a microprocessor in signal communication with and operational control of the digital memory element, the RFID transmitter and the RFID receiver;
removably coupling a machine condition advisor (MCA) to the machine, the MCA comprising a sensor input and a microprocessor, wherein the microprocessor operates in accordance with a series of machine condition instructions;
query machine condition sensors to obtain machine condition measurement data through the MCA;
establishing point setup data within the RFID point setup data memory block, wherein the point set up data includes at least one machine condition warning level associated with each monitored machine condition;
transferring the obtained machine condition measurement data to and recording the obtained machine condition measurement data in the historic measurement memory blocks;
determining a time relative to the machine condition sensor query and recording the relative time in the RFID transponder digital memory element, wherein the relative time is associated with the recorded obtained machine condition measurement data; and
utilizing the relative times and recorded obtained machine condition measurement data to determine machine condition trending.

10. The method of monitoring a health of a machine as recited in claim 9, the method further comprising a step of:
determining machine condition trending utilizing the MCA microprocessor as directed by an instruction set.

11. The method of monitoring a health of a machine as recited in claim 9, the method further comprising a step of:
informing a service technician of the determined machine condition trending.

12. The method of monitoring a health of a machine as recited in claim 9, the method further comprising a step of:
informing a service technician of the determined machine condition trends, wherein the determined machine condition trending is presented in a graphical format.

13. The method of monitoring a health of a machine as recited in claim 9, the method further comprising steps of:
establishing a warning level for each machine condition measurement;
storing the warning level established for each machine condition measurement in the RFID transponder;
comparing the obtained machine condition measurement data with the associated warning level to determine if the obtained machine condition measurement data is above the established warning level; and
informing a technician of a condition warranting a warning when the obtained machine condition measurement data is above the established warning level.

14. The method of monitoring a health of a machine as recited in claim 13, the method further comprising a step of:
informing a service technician of the determined machine condition trends, wherein the determined machine condition trending is presented in a graphical format.

15. The method of monitoring a health of a machine as recited in claim 9, the method further comprising steps of:
establishing an alert level and a danger level with each machine condition measurement; and
storing the alert level and the danger level established for each machine condition measurement in the RFID transponder.

16. The method of monitoring a health of a machine as recited in claim 15, the method further comprising steps of:
determining an operational status of the machine by comparing each machine condition measurement with each associated established alert level and danger level to determine if the machine condition is above one of the alert level and the danger level; and
conveying the operational status of the machine to an individual monitoring the machine condition.

17. The method of monitoring a health of a machine as recited in claim 15, the method further comprising a step of:
informing a service technician of the determined machine condition trends.

18. The method of monitoring a health of a machine as recited in claim 15, the method further comprising a step of:
informing a service technician of the determined machine condition trends, wherein the determined machine condition trending is presented in a graphical format.

19. The method of monitoring a health of a machine as recited in claim 9, the method further comprising a step of:
reading data stored on the RFID transponder using a radio frequency identification (RFID) reader.
